(19) United States
(12) Patent Application Publication
(10) Pub. No.: US 2002/0060879 A1
(43) Pub. Date: May 23, 2002

(54) Thin film magnetic head having a plurality of coil layers

(75) Inventor: Kiyoshi Sato, Niigata-Ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/010,638

(22) Filed: Nov. 13, 2001

(30) Foreign Application Priority Data
Nov. 21, 2000 (JP) 2000-353992

(51) Int. Cl. G11B 5/147

(52) U.S. Cl. 360/126

(57) ABSTRACT

A thin film magnetic head having a plurality of coils is capable of recording with higher density. A magnetic pole section for restricting a track width is formed between a lower core layer and an upper core layer, and two coil layers are tiered between a reference surface and a lower core layer through the intermediary of a coil insulating layer. This allows a magnetic path to be shortened. As a result, narrower tracks and lower inductance can be both achieved, and the narrower tracks combined with faster data transfer enable higher-density recording to be attained.

### BACKGROUND OF THE INVENTION

1. Field of the Invention

The present invention relates to a recording thin film magnetic head used for, for example, a flying magnetic head or the like. More particularly, the present invention relates to a thin film magnetic head that allows spiral-pattern coil layers to be efficiently disposed in a small area when a magnetic path of a recording magnetic field is shortened.

2. Description of the Related Art

FIG. 19 is a longitudinal sectional view of a conventional recording thin film magnetic head (inductive head), the surface at the left end in the drawing being the surface that faces a recording medium.

The thin film magnetic head has a lower core layer 1 and an upper core layer 13 that are made of a ferromagnetic material and formed by plating or the like. In the upper core layer 13, the distal end opposing the recording medium provides a magnetic pole 13a. At the surface facing the recording medium, the lower core layer 1 and the magnetic pole 13a face each other with a very small gap provided therebetween, and a nonmagnetic gap layer 16 is disposed in the very small gap. A magnetic connecting portion 13b where the upper core layer 13 is magnetically connected to the lower core layer 1 is provided at the back in the height direction away from the surface opposing the recording medium.

Provided around the magnetic connecting portion 13b are coil layers 9 and 11 formed in a spiral pattern in a plane parallel to the lower core layer 1. A recording magnetic field is induced from the coil layers 9 and 11 to the lower core layer 1 and the upper core layer 13.

Magnetic data is recorded in a recording medium, such as a hard disk, by a recording magnetic field that leaks forward from the gap between the magnetic pole 13a and the lower core layer 1.

High-density recording is desired for recording magnetic data in a hard disk or other recording media. To accomplish high-density recording of magnetic data into a recording medium, it is necessary (1) to reduce the width of the magnetic pole 13a in a track width thereby to narrow the recording tracks in the recording medium, and (2) to increase the speed for transferring recording signal data to a magnetic head. Increasing the data transferring speed means increasing the frequency of recording current supplied to the coil layers.

Referring to the structure of the conventional magnetic head shown in FIG. 19, in relation to (1) mentioned above, the magnetic pole 13a is a part of the upper core layer 13, and the magnetic pole 13a is provided at the distal end of a slope portion 13c of the upper core layer 13. Therefore, it is difficult to integrally form the magnetic pole 13a having a smaller width in the track width direction at the end of the slope portion 13c.

Regarding (2) above, to increase the frequency of recording current, the inductance of the entire magnetic head must be reduced. To reduce the inductance, it is required to reduce the dimension from the far end of the joint surface between the magnetic pole 13a and the gap layer 16 to the magnetic connecting portion 13b at the rear so as to shorten the magnetic path of the lower core layer 1 and the upper core layer 13.

However, the coil layers are present between the lower core layer 1 and the upper core layer 13; therefore, if the magnetic path is shortened, then the coil layers have to be disposed within the shorter magnetic path and in an extremely restricted area sandwiched by the lower core layer 1 and the upper core layer 13. Furthermore, an increase in the DC resistance of the coil layers results in an increase in the Joule heat produced by the coil layers, and the heat will affect the recording characteristics of the magnetic head or the characteristics of a magnetic reproducing device provided together with the magnetic head. For this reason, the sectional area of each coil layer must be maximized, and the coil layers must have a certain number of turns in order to maintain overwrite characteristics.

In the magnetic head shown in FIG. 19, as a measure for shortening the magnetic path of the core layers and for maximizing the number of turns of the coil layers having maximized sectional areas, the lower coil layer 9 formed in a plane spiral pattern and the upper coil layer 11 also formed in a plane spiral pattern are vertically stacked in two layers between the lower core layer 1 and the upper core layer 13.

In the magnetic head having the structure shown in FIG. 19, however, the two coil layers 9 and 11 are provided above the lower core layer 1, so that an insulating layer 12 made of an organic material covering the coil layers 9 and 11 is formed, considerably bulging upward. This results in an extremely large slope angle of the slope portion 13c of the upper core layer 13 formed on the top surface of the insulating layer 12. Hence, the vertical curvature of the upper core layer 13 will be accordingly large, making it extremely difficult to form the upper core layer 13 to have an even thickness by plating. In addition, it will be also difficult to form the magnetic pole 13a having a small track width dimension at the end of the slope portion 13c having the large slope angle.

Furthermore, in order to shorten the magnetic path in the height direction and to dispose the coil layers having a predetermined number of turns between the lower core layer 1 and the upper core layer 13, a width L1 of each coil layer in the direction of the magnetic path (the height direction) must be minimized, and a film thickness H1 must be increased to make up for the smaller width L1 thereby to obtain a largest possible sectional area. If, however, coil layers having vertically long sectional areas in which H1 is larger than L1, then the insulating layer 12 will further bulges upward, leading to an even larger slope angle of the slope portion 13c of the upper core layer 13.

Furthermore, since the coil layers have to be concentrated in the height direction, an interval L2 in the height direction of the gap between the individual coil layers will be small. Hence, the gap will be also vertically long, meaning that the height H1 is larger than the interval L2. As a result, when an attempt is made to form the coil layers having vertically long sections by frame plating process or the like in resist drawing patterns, the resist drawing patterns will be short-circuited, frequently leading to defectively formed coil layers. Even if the coil layers are formed with high accuracy, it will be impossible to securely set the insulating material between the vertically long gaps, frequently resulting in failure wherein a void is undesirably formed in a gap between the coil layers.

### SUMMARY OF THE INVENTION

Accordingly, the present invention has been made with a view toward solving the problems with the prior art described above, and it is a first object of the invention to provide a head structure that includes a magnetic pole having a short width in a track width direction and allows an upper core having a gentle slope portion at its front to be formed, and to minimize the length of the magnetic path of a core and efficiently dispose coil layers within the short magnetic path in the head structure.

A second object of the present invention is to obtain a maximized sectional area of each coil layer thereby to control Joule heat as much as possible, while securing an adequate number of turns of each coil at the same time in a limited area resulting from the aforesaid shortened magnetic path.

A third object of the present invention is to allow the coil layers to be disposed as compactly as possible in the limited area and to restrain the occurrence of defects in the films of the coil layers and the occurrence of insulation failure in a gap between the coil layers.

To these ends, according to one aspect of the present invention, there is provided a thin film magnetic head wherein: at a surface side opposing a recording medium, a lower core layer and an upper core layer are positioned with a gap provided therebetween in a direction of sliding against a recording medium, and a magnetic pole section constituted by a lower magnetic pole layer having a predetermined width in a track width direction, a gap layer, and an upper magnetic pole layer, or by the gap layer and the upper magnetic pole layer, is provided between the lower core layer and the upper core layer; a connecting portion for magnetically connecting the lower core layer and the upper core layer is provided at the rear in a height direction away from the opposing surface; coil layers in spiral patterns are formed around the connecting portion; and the spiral patterns of the coil layers are disposed such that they are overlapped in a plurality of layers in the above sliding direction in an area sandwiched between a reference surface, which is obtained by extending the connecting surface of the lower core layer and the magnetic pole section in the height direction, and the lower core layer.

In the present invention, at the end surface opposing the recording medium, the gap layer and the upper magnetic pole layer are formed between the lower core layer and the upper core layer, and the dimension of the magnetic pole layer in the track width direction can be controlled independently of the formation of the upper core layer, thereby achieving magnetic recording with narrower tracks. The magnetic head having this structure makes it possible to secure a coil formation area at the back of the gap layer and the upper magnetic pole layer. The coil layers are efficiently disposed in the coil formation area so as to permit a shorter magnetic path of a core between a magnetic pole and the magnetic connecting portion.

Two or more coil layers are vertically disposed in an area below the top surface of the upper magnetic pole layer thereby to allow the magnetic path to be made shorter.

It is unnecessary to provide a slope portion having a large slope angle at the front of the upper core layer, making it possible to form the upper core layer having an even film thickness.

In other words, the present invention permits recording with narrower tracks to be accomplished by reducing the dimension of a magnetic pole in the track width direction, and allows recording at a higher density to be achieved by shortening a magnetic path thereby to reduce the inductance thereof.

Preferably, the section of the coil layer positioned in the area sandwiched between a reference surface and the lower core layer is formed such that the length of a bottom side thereof parallel to the lower core layer is larger than the film thickness of the coil layer. In other words, the coil layer is formed to have a square or horizontally long sectional shape.

When the coil layers having a predetermined number of turns are formed in the limited coil formation area, vertically overlapping the coil layers that have the square or horizontally long sectional shape makes it possible to secure larger sectional areas so as to restrain an increase in the DC resistance of the coils, as compared with a case where coil layers having vertically longer sectional shapes are compactly disposed in a lateral direction. Moreover, providing the coil layers with the square or horizontally long sectional shapes makes it possible to reduce the thickness of resist layers used for forming the coil layers, allowing the coil layers to be formed with high pattern accuracy and narrower pitches to be achieved.

Preferably, the dimension of the pitch or gap between the coil layers in the direction parallel to the lower core layer is greater than the film thickness of the coil layers.

Forming the pitches of the coil layers into square or horizontally long shapes allows an insulating material to easily fit in the pitches, thus ensuring reliable insulation between the coil layers.

For example, in the connecting portion, a back gap layer made of a magnetic material is formed on the lower core layer, and the back gap layer and the upper core layer are magnetically connected. The coil layers may be positioned in an area sandwiched between a reference surface, which connects the top surface of the magnetic pole section and the top surface of the back gap layer, and the lower core layer.

In the structure, the coil layers are formed between the magnetic pole section and the back gap layer, thus making it possible to secure a large area for forming the coil layers. Moreover, the proximal end of the upper core layer can be connected onto the back gap layer, permitting easier formation of a magnetic path from the upper core layer to the lower core layer.

In this case, a Gd deciding layer for deciding a depth Gd of the gap layer in the height direction is provided on the lower core layer. Positioning at least the bottommost coil layer adjacent to the lower core layer at the far side in the height direction of the Gd deciding layer allows the bottommost coil layer to be formed in the vicinity of the lower core layer. Thus, the coil layers can be compactly disposed.

Preferably, the insulating layer that covers the lower coil layer and the insulating layer that covers the upper coil layer are both formed of an inorganic insulating material. At this time, forming the sections of the coil layers into square or horizontally long shapes as mentioned above makes it possible to cover the top surfaces of the coil layers with the insulating layers of thinner films, permitting easier formation of the insulating layers. In addition, forming the gaps between the coil layers into square or horizontally long shapes allows the gaps to be securely filled with the insulating layers.

Preferably, the depth from the distal end of the Gd deciding layer, which distal end is adjacent to the surface opposing a recording medium, to the connecting portion for magnetically connecting the lower core layer and the upper core layer ranges from 2 μm to 6 μm. In the present invention, even when the distance is reduced as mentioned above, it is possible to properly and compactly form coil layers having larger sectional areas in a limited coil formation area, effectively shortening a magnetic path.

As an alternative, another coil layer may be disposed between the reference surface and the upper core layer.

### BRIEF DESCRIPTION OF THE DRAWINGS

FIG. 1 is a partial front view showing a structure of a thin film magnetic head according to an embodiment of the present invention;

FIG. 2 is a partial longitudinal sectional view of the thin film magnetic head taken at the line II-II shown in FIG. 1;

FIG. 3 is a partial enlarged sectional view of the thin film magnetic head shown in FIG. 2;

FIG. 4 is a partial longitudinal sectional view showing a structure of a thin film magnetic head according to another embodiment of the present invention;

FIG. 5 is a partial longitudinal sectional view showing a structure of a thin film magnetic head according to another embodiment of the present invention;

FIG. 6 is a process diagram showing a manufacturing process step of the thin film magnetic head shown in FIG. 2;

FIG. 7 is a process diagram showing a process step carried out after the step shown in FIG. 6;

FIG. 8 is a process diagram showing a process step carried out after the step shown in FIG. 7;

FIG. 9 is a process diagram showing a process step carried out after the step shown in FIG. 8;

FIG. 10 is a process diagram showing a process step carried out after the step shown in FIG. 9;

FIG. 11 is a process diagram showing a process step carried out after the step shown in FIG. 10;

FIG. 12 is a process diagram showing a process step carried out after the step shown in FIG. 11;

FIG. 13 is a diagram illustrating a thin film magnetic head simulation for calculating the sectional area of a conductive portion of a coil layer 44 when the distance from the distal end of a Gd deciding layer, which distal end is adjacent to the surface opposing a recording medium, to a back gap layer 36 is set to 10 μm, and the coil layer 44 including only one layer is formed between a magnetic pole 24 and the back gap layer 36, as a comparative example;

FIG. 14 is a diagram illustrating a thin film magnetic head simulation for calculating the sectional area of a conductive portion of a coil layer 44 when the distance from the distal end of a Gd deciding layer, which distal end is adjacent to the surface opposing a recording medium, to a back gap layer 36 is set to 10 μm, and the coil layer 44 including two layers is formed between a magnetic pole section 24 and the back gap layer 36 in the same coil formation area and at the same pitches as those shown in FIG. 13, as an embodiment;

FIG. 15 is a diagram illustrating a thin film magnetic head simulation for calculating the sectional area of a conductive portion of a coil layer 44 when the distance from the distal end of a Gd deciding layer, which distal end is adjacent to the surface opposing a recording medium, to a back gap layer 36 is set to 8 μm, and the coil layer 44 including only one layer is formed between a magnetic pole section 24 and the back gap layer 36, as a comparative example;

FIG. 16 is a diagram illustrating a thin film magnetic head simulation for calculating the sectional area of a conductive portion of a coil layer 44 when the distance from the distal end of a Gd deciding layer, which distal end is adjacent to the surface opposing a recording medium, to a back gap layer 36 is set to 8 μm, and the coil layer 44 including two layers is formed between a magnetic pole section 24 and the back gap layer 36 in the same coil formation area and at the same pitches as those shown in FIG. 15, as an embodiment;

FIG. 17 is a diagram illustrating a thin film magnetic head simulation for calculating the sectional area of a conductive portion of a coil layer 44 when the distance from the distal end of a Gd deciding layer, which distal end is adjacent to the surface opposing a recording medium, to a back gap layer 36 is set to 7 μm, and the coil layer 44 including only one layer is formed between a magnetic pole section 24 and the back gap layer 36, as a comparative example;

FIG. 18 is a diagram illustrating a thin film magnetic head simulation for calculating the sectional area of a conductive portion of a coil layer 44 when the distance from the distal end of a Gd deciding layer, which distal end is adjacent to the surface opposing a recording medium, to a back gap layer 36 is set to 7 μm, and the coil layer 44 including two layers is formed between a magnetic pole section 24 and the back gap layer 36 in the same coil formation area and at the same pitches as those shown in FIG. 17, as an embodiment; and

FIG. 19 is a partial longitudinal sectional view showing a conventional thin film magnetic head.

### DESCRIPTION OF THE PREFERRED EMBODIMENTS

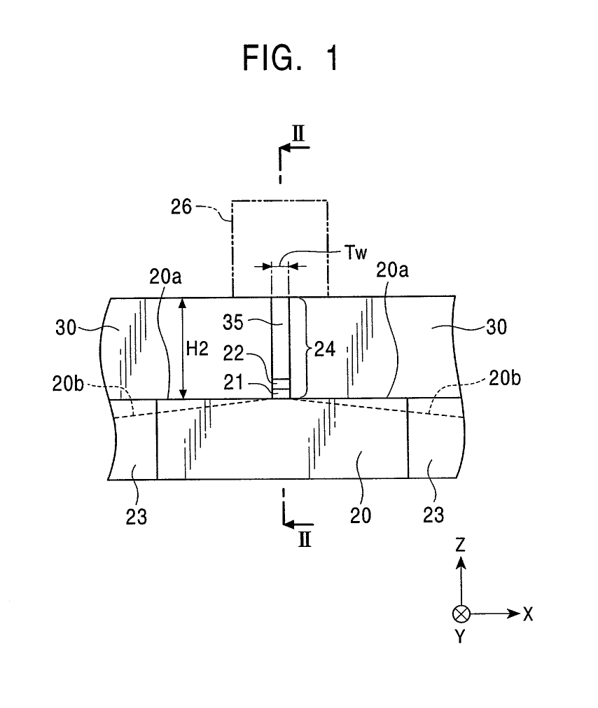

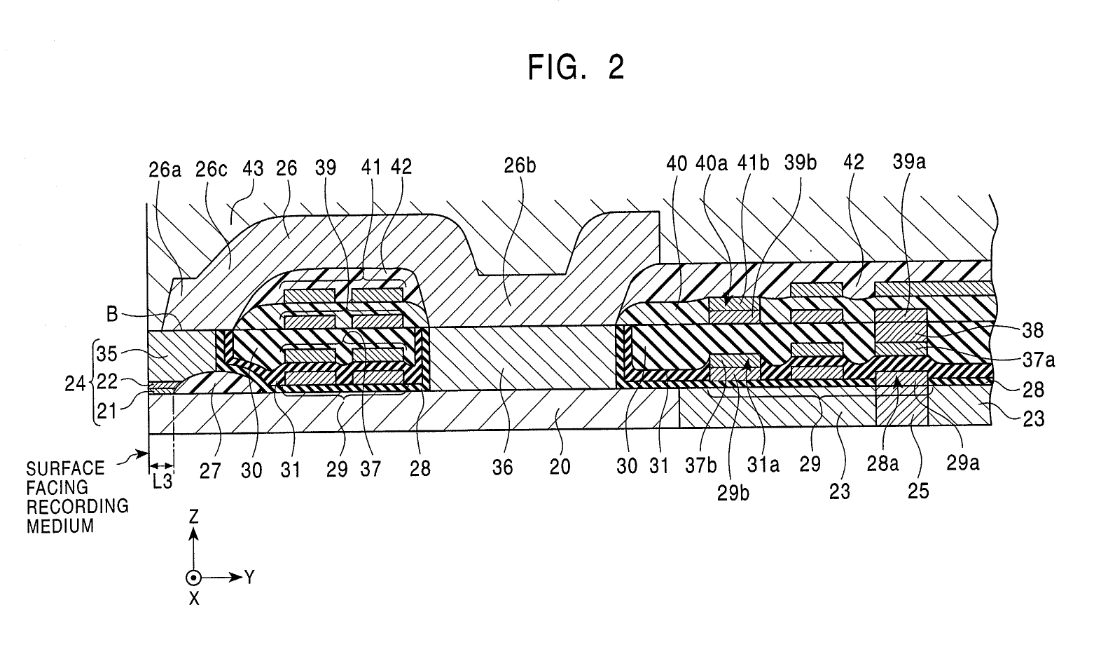

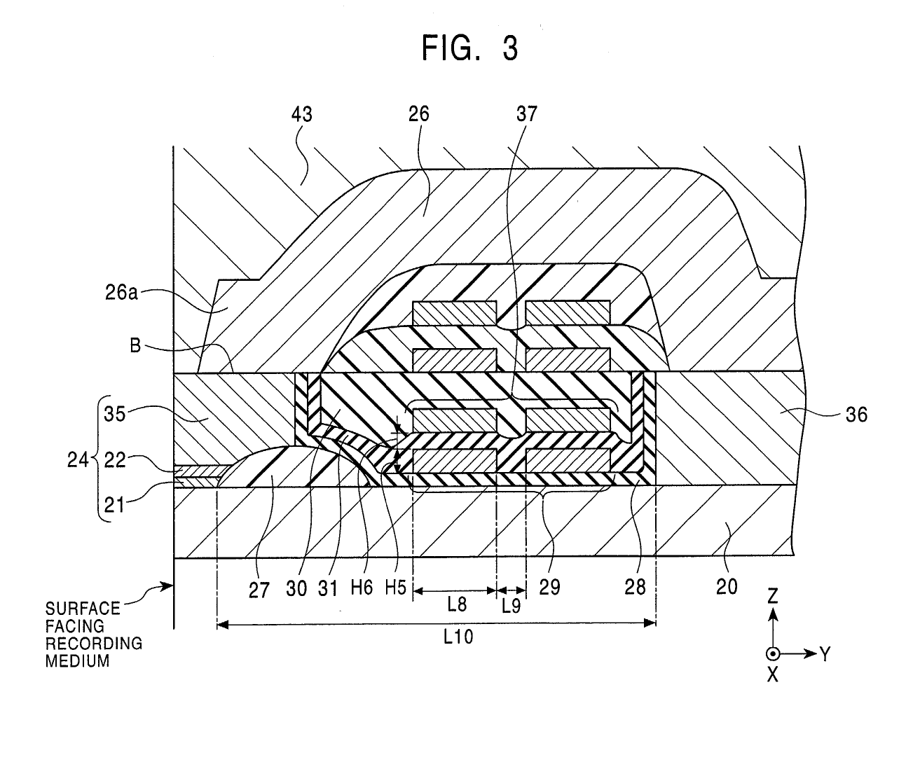

FIG. 1 a partial front view showing a structure of a thin film magnetic head according to the present invention, FIG. 2 is a partial longitudinal sectional view of the thin film magnetic head taken at the line II-II shown in FIG. 1, and FIG. 3 is a partial longitudinal sectional view enlarging a portion of the structure from the surface of the thin film magnetic head according to the present invention shown in FIG. 2, the surface opposing a recording medium, to a back gap layer 36.

The thin film magnetic head shown in FIG. 1 is a recording inductive head. In the present invention, a reproducing head (an MR head, a GMR head, or a TMR head) utilizing the magnetoresistive effect may be deposited under the inductive head.

A lower core layer 20 shown in FIG. 1 and FIG. 2 is formed of a magnetic material, such as Permalloy. If a reproducing head is deposited under the lower core layer 20, a shielding layer for protecting a magnetoresistive device from noises may be provided separately from the lower core layer 20, or the lower core layer 20 may serve as an upper shielding layer of the reproducing head rather than providing the shielding layer.

Referring to FIG. 2, a lifting layer 25 made of a magnetic material is formed at the rear in the height direction (in a direction Y in the drawing) away from the lower core layer 20.

Insulating layers 23 made of Al₂O₃ or the like are formed on both sides of the lower core layer 20, as shown in FIG. 1, and between the lower core layer 20 and the lifting layer 25 and at the rear of the lifting layer 25 in the height direction, as shown in FIG. 2. Furthermore, as shown in FIG. 1, a top surface 20a of the lower core layer 20 that extends from the proximal end of a lower magnetic pole layer 21, which will be discussed hereinafter, may be formed to extend in a direction parallel to the direction of a track width (a direction X in the drawing). Alternatively, slope surfaces 20b and 20b that are inclined in directions away from the upper core layer 26 may be formed.

As shown in FIGS. 1 and 2, a magnetic pole section 24 on the lower core layer 20 is formed so that it is exposed on the surface opposing a recording medium. In this embodiment, the magnetic pole section 24 may be compared to a track width restriction section having a track width Tw. The track width Tw is preferably 0.5 μm or less.

According to the embodiment shown in FIGS. 1 and 2, the magnetic pole section 24 has a laminated structure of three layer films, namely, the lower magnetic pole layer 21, a gap layer 22, and an upper magnetic pole layer 35. The following will describe the magnetic pole layers 21 and 35 and the gap layer 22.

Referring to FIGS. 1 and 2, the lower magnetic pole layer 21 that provides the bottommost layer of the magnetic pole section 24 is formed by plating on the lower core layer 20. The lower magnetic pole layer 21 is magnetically connected with the lower core layer 20. The lower magnetic pole layer 21 may be formed of a material that is either the same as or different from that of the lower core layer 20, and may be formed of either a single-layer film or a multi-layer film. The height of the lower magnetic pole layer 21 is set to, for example, approximately 0.3 μm.

Referring again to FIGS. 1 and 2, the nonmagnetic gap layer 22 is formed on the lower magnetic pole layer 21.

In the invention, preferably, the gap layer 22 is formed of a nonmagnetic metal material and formed on the lower magnetic pole layer 21 by plating. In the invention, preferably, one of or two or more of NiP, NiPd, NiW, NiMo, NiRh, Au, Pt, Rh, Pd, Ru, Cr, and NiCu are selected as the nonmagnetic metal material. The gap layer 22 may be formed either of a single-layer film or a multi-layer film. The gap layer 22 may be made of an insulating material, such as SiO₂. The height of the gap layer 22 is formed to have a height of, for example, approximately 0.2 μm.

An upper magnetic pole layer 35 magnetically connected to an upper core layer 26, which will be discussed hereinafter, is formed by plating on the gap layer 22. The upper magnetic pole layer 35 may be formed of a material that is either the same as or different from that of the upper core layer 26, and may be formed of either a single-layer film or a multi-layer film. The height of the upper magnetic pole layer 35 is set to, for example, approximately 2.0 μm to approximately 3.0 μm.

As described above, using a nonmagnetic metal material for the gap layer 22 makes it possible to continuously form the lower magnetic pole layer 21, the gap layer 22, and the upper magnetic pole layer 35 by plating.

In the invention, the structure of the magnetic pole section 24 is not limited to the three-layer film mention above. Alternatively, the magnetic pole section 24 may be formed of two layers, namely, the gap layer 22 and the upper magnetic pole layer 35. In this case, it is preferred to leave the surface that opposes the upper magnetic pole layer 35 via the gap layer 22 on the lower core layer 20, and to cut the top surface of the lower core layer 20 that extends to both sides in the track width direction of the surface by milling or the like so as to form the lower core layer 20 into a convex shape as observed from the surface facing a recording medium. This makes it possible to properly restrain side fringing from the upper magnetic pole layer 35.

As described above, the lower magnetic pole layer 21 and the upper magnetic pole layer 35 constituting the magnetic pole section 24 may be formed of the same material as or a different materials from that of the core layers to which the magnetic pole layers are magnetically connected. Preferably, in order to improve recording density, the lower magnetic pole layer 21 and the upper magnetic pole layer 35 opposing the gap layer 22 have a saturated magnetic flux density that is higher than the saturated magnetic flux density of the core layers to which the magnetic pole layers are magnetically connected. The higher saturated magnetic flux density of the lower magnetic pole layer 21 and the upper magnetic pole layer 35 allows a recording magnetic field to be concentrated in the vicinity of the gap with a resultant higher recording density.

As shown in FIG. 2, the magnetic pole section 24 is formed from the surface opposing a recording medium (ABS surface) in the height direction (the direction Y in the drawing).

Referring to FIG. 2, a Gd deciding layer 27 made of, for example, a resist or the like is formed between the lower core layer 20 and the magnetic pole section 24. The surface of the Gd deciding layer 27 is formed to have, for example, a curved shape. The upper magnetic pole layer 35 is formed to extend onto the curved surface, as shown in FIG. 2. The Gd deciding layer 27 may be made of any nonmagnetic material, including, for example, an inorganic insulating material, such as Al₂O₃, or a nonmagnetic metal material, such as Cu.

Referring again to FIG. 2, a distance L3 from the distal end of the Gd deciding layer 27, which distal end is adjacent to the surface facing a recording medium, to the surface facing a recording medium is restricted as a gap depth Gd, and set to a predetermined value because the gap depth Gd significantly influences the electrical characteristics of the thin film magnetic head.

Furthermore, a back gap layer (connection) 36 made of a magnetic material is formed at the rear in the height direction (the direction Y in the drawing) on the lower core layer 20, as shown in FIG. 2. The back gap layer 36 may be formed of the same magnetic material as or a different material from that of the lower core layer 20.

As shown in FIG. 2, at the rear in the height direction (the direction Y in the drawing) of the magnetic pole section 24, a first coil layer 29 is spirally film-formed around the back gap layer 36 on the lower core layer 20 through the intermediary of a coil insulating underlying layer 28. The coil insulating underlying layer 28 is preferably formed of an insulating material made of at least one of, for example, AlO, Al₂O₃, SiO₂, Ta₂O₅, TiO, AlN, AlSiN, TiN, SiN, Si₃N₄, NiO, WO, WO₃, BN, CrN, and SiON.

The first coil layer 29 is pattern-formed by using copper (Cu) or the like having a low electrical resistance.

As shown in FIG. 2, a hole 28a is formed in the coil insulating underlying layer 28 in which a winding end 29a of the first coil layer 29 is formed. The winding end 29a is formed in the hole 28a, the winding end 29a being in electrical connection with the lifting layer 25.

Furthermore, a coil insulating layer 31 is formed such that it covers the first coil layer 29 and fills the pitch gaps of the first coil layer 29, as shown in FIG. 2. The coil insulating layer 31 is preferably formed of an inorganic insulating material. The inorganic insulating material is preferably at least one of AlO, Al₂O₃, SiO₂, Ta₂O₅, TiO, AlN, AlSiN, TiN, SiN, Si₃N₄, NiO, WO, WO₃, BN, CrN, and SiON.

According to the invention, a second coil layer 37 is spirally formed around the back gap layer 36 on the coil insulating layer 31, as shown in FIG. 2. A hole 31a is formed in the coil insulating layer 31 in which a winding center 37b of the second coil layer 37 is formed, and the winding center 37b is formed in the hole 31a. The winding center 37b of the second coil layer 37 is in electrical connection with a winding center 29b of the first coil layer 29.

A coil insulating layer 30 is formed such that it covers the second coil layer 37 and fills the pitch gap of the second coil layer 37, as shown in FIG. 2. When the joining surface between the magnetic pole section 24 and the upper core layer 26 is defined as a reference surface B, the surface of the coil insulating layer 30 is flush with the reference surface B. The coil insulating layer 30 is preferably formed of an inorganic insulating material. The inorganic insulating material is preferably at least one of AlO, Al₂O₃, SiO₂, Ta₂O₅, TiO, AlN, AlSiN, TiN, SiN, Si₃N₄, NiO, WO, WO₃, BN, CrN, and SiON.

In the embodiment shown in FIG. 2, a contact 38 is formed on a winding end 37a of the second coil layer 37, the contact 38 penetrates the coil insulating layer 30 until it is exposed on the front surface of the coil insulating layer 30. The contact 38 is formed by plating, using an electrically conductive material, such as copper or the like, which has low electrical resistance.

In the embodiment shown in FIG. 2, a third coil layer 39 is windingly formed around a proximal end (magnetic connection) 26b of the upper core layer 26, which will be discussed hereinafter, on the coil insulating layer 30. A winding end 39a of the third coil layer 39 is electrically connected onto the contact 38.

A coil insulating layer 40 is formed such that it covers the third coil layer 39 and fills the pitch gap of the third coil layer 39. The coil insulating layer 40 is formed of an organic insulating material, such as a resist or a polyimide. Alternatively, the coil insulating layer 40 may be formed of an inorganic insulating material.

A fourth coil layer 41 is windingly formed around a proximal end 26b of the upper core layer 26 on the coil insulating layer 40. A hole 40a is formed in the coil insulating layer 40 in which a winding center 41b of the fourth coil layer 41 is formed, and the winding center 41b is formed in the hole 40a. The winding center 41b of the fourth coil layer 41 and the winding center 39b of the third coil layer 39 are in electrical connection.

A coil insulating layer 42 is formed such that it covers the fourth coil layer 41 and fills the pitch gap of the fourth coil layer 41. The coil insulating layer 42 is formed of an organic insulating material, such as a resist or a polyimide. Alternatively, the coil insulating layer 42 may be formed of an inorganic insulating material.

The upper core layer 26 is pattern-formed on the coil insulating layer 42 by, for example, the frame plating process or the like. A distal end 26a of the upper core layer 26 is formed on the magnetic pole section 24, and magnetically connected with the upper magnetic pole layer 35. The distal end 26a of the upper core layer 26 is positioned away from the surface opposing a recording medium in the height direction (in the direction Y in the drawing), and the distal end surface of the distal end 26a is formed to have a slope that inclines in the height direction as it inclines away from the lower core layer 20. The proximal end 26b of the upper core layer 26 is formed on the back gap layer (connection) 36. This forms the magnetic path extending from the upper core layer 26 to the lower core layer 20 and the magnetic pole section 24.

A protective layer 43 made of Al₂O₃ or the like is formed on the upper core layer 26.

According to the present invention, as shown in FIG. 1 and FIG. 2, the magnetic pole section 24 is formed between the upper core layer 26 and the lower core layer 20, and the dimension of the magnetic pole section 24 in the track width direction (the direction X in the drawing) can be adjusted independently from the upper core layer 26. This arrangement permits narrower tracks to be achieved.

According to the embodiment shown in FIG. 2, a coil forming area can be secured behind the magnetic pole section 24.

According to the present invention, the coil layers 29 and 37 in the spiral patterns are disposed such that they are overlapped in a plurality of layers in a direction Z in the drawing (in the sliding direction relative to the recording medium) in the area sandwiched between the reference surface B and the lower core layer 20. The reference surface B is obtained by extending, in the height direction, the joining surface of the upper magnetic pole layer 35 and the upper core layer 26 making up the magnetic pole section 24.

Thus, it is possible to shorten the magnetic path from the distal end 26a to the proximal end 26b of the upper core layer 26 by disposing two or more of the coil layers 29 and 37 within the area between the lower core layer 20 and the reference surface B. Therefore, the invention allows narrower tracks and reduced inductance to be realized, permitting a higher recording density to be achieved.

In the embodiment shown in FIG. 2, the two layers of the coil layers 39 and 41 are formed between the reference surface B and the upper core layer 26. According to the present invention, however, all coil layers can be compactly formed between the reference surface B and the lower core layer 20. Thus, when a predetermined number of turns is ensured, the coils can be laid out relatively freely, as compared with the prior art. Hence, the bulges of the coil insulating layers 40 and 42 formed on the reference surface B can be easily reduced, as compared with the prior art. It is possible, therefore, to avoid forming the slope 26c having a large angle of gradient at the front end of the upper core layer 26, allowing the upper core layer 26 to be formed with high pattern accuracy and a uniform film thickness.

Furthermore, even when the two layers of the coil layers 39 and 41 are stacked between the reference surface B and the upper core layer 26, as in the case of the embodiment shown in FIG. 2, or more than two layers of coil layers are stacked therebetween, the bulge of the coil insulating layer formed over the reference surface B can be minimized to allow the upper core layer 26 to be easily formed with a uniform film thickness. This is because the present invention makes it possible to form the coil layers to have horizontally long sectional shapes, as it will be explained hereinafter.

Furthermore, in the embodiment shown in FIG. 2, the back gap layer 36 is formed on the lower core layer 20, and the top surface of the back gap layer 36 coincides with the reference surface B. Therefore, the proximal end 26b of the upper core layer 26 can be connected onto the back gap layer 36, allowing the magnetic path from the upper core layer 26 to the lower core layer 20 to be easily formed. It is also possible to secure an ample coil formation area between the magnetic pole section 24 and the back gap layer 36.

Furthermore, according to the present invention, the Gd deciding layer 27 for deciding the gap depth (Gd) of the gap layer 22 in the height direction (in the direction of Y in the drawing) is provided on the lower core layer 20, and the first coil layer 29 that provides the bottommost layer is positioned at the back side of the Gd deciding layer 27, i.e., in the direction of Y in the drawing, as shown in FIG. 2. With this arrangement, the first coil layer 29 can be formed in the vicinity of the lower core layer 20, so that a plurality of coil layers can be compactly formed within the limited coil formation area between the reference surface B and the lower core layer 20.

Moreover, in the present invention, the coil layers 29 and 37 positioned in the area sandwiched between the reference surface B and the lower core layer 20 are preferably formed to have a sectional shape in which a length L8 of the bottom side thereof parallel to the lower core layer 20 is equal to a film thickness H5 or more of the coil layer, as shown in FIG. 3. In other words, to form the coil layers of a predetermined number of turns in a limited coil formation area, forming the coil layers to have square or horizontally long sections allows the coil layers to have larger sectional areas than in a case where coil layers having vertically longer sections are compactly disposed in the lateral direction, thus making it possible to prevent an increase in the DC resistance of the coils. In addition, despite the larger sectional areas, coil layers of a predetermined number of turns can be formed, allowing good overwrite characteristics to be maintained.

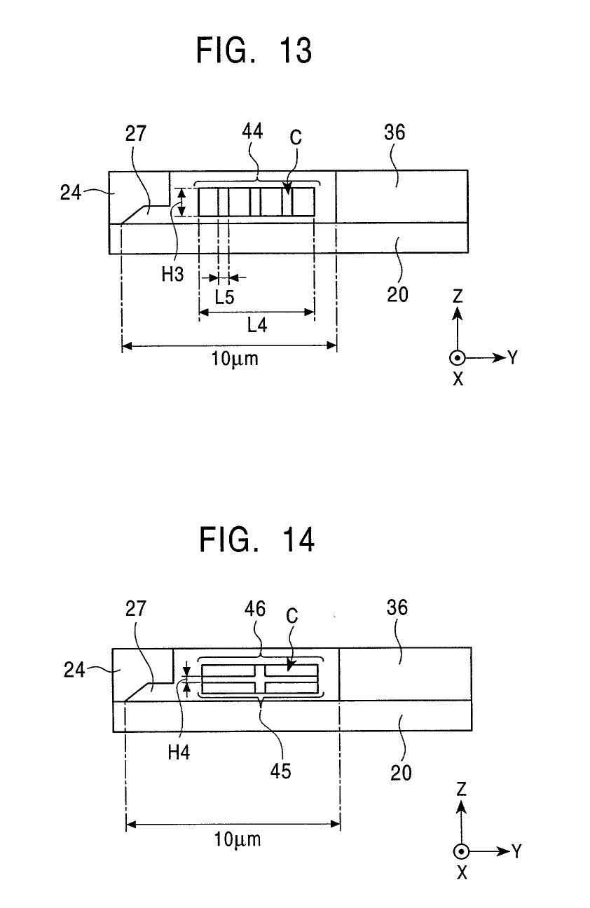

FIG. 13 through FIG. 18 illustrate the simulations for calculating the sectional areas of coil layers when thin film magnetic heads are cut in the height direction or the direction Y in the drawings. The thin film magnetic heads include comparative examples in which only one layer, namely, coil layer 44, is formed between the magnetic pole section 24 and the back gap layer 36, and embodiments in which two coil layers 45 and 46 are formed laminated between the magnetic pole section 24 and the back gap 36.

In the comparative examples shown in FIGS. 13, 15, and 17 wherein only one layer, the coil layer 44, is included, the number of turns was set to 4, and the coil layer 44 was formed to have a vertically long section. On the other hand, in the embodiments shown in FIGS. 14, 16, and 18 wherein the two coil layers 45 and 46 are formed, the number of turns was set to 2, so that the total number of turns was 4, which is the same as the number of turns in the comparative examples wherein only one coil layer 44 is used. The coil layers 45 and 46 were formed to have horizontally long sections.

Referring to FIG. 13, the single coil layer 44 is formed between the magnetic pole section 24 and the back gap layer 36 in a coil formation area C. The distance from the distal end of the Gd deciding layer 27, which distal end is adjacent to the surface opposing a recording medium, to the back gap layer 36 was set to 10 μm.

The length of the coil formation area C in the height direction was set to L4, and a height H3 thereof was set to 1.5 μm. A pitch interval L5 between conductive portions of the coil layer 44 was set to 0.8 μm.

The result of the simulation shown in FIG. 13 indicated that the length of each conductive portion in the height direction was 1.0 μm, the height was 1.5 μm, and therefore, the sectional area of the conductive portion was 1.5 μm².

Referring now to FIG. 14, the two coil layers 45 and 46 are formed between the magnetic pole section 24 and the back gap layer 36 in the coil formation area C. As in the case shown in FIG. 3, the distance from the distal end of the Gd deciding layer 27, which distal end is adjacent to the surface opposing a recording medium, to the back gap layer 36 was set to 10 μm.

The coil formation area C was set to the same size as that shown in FIG. 13, and the pitch interval between conductive portions was set to 0.6 μm. An interval H4 between the two coil layers 45 and 46 was set to 0.3 μm.

The result of the simulation shown in FIG. 14 indicated that the length of each conductive portion in the height direction was 2.9 μm, the height was 0.6 μm, and therefore, the sectional area of each conductive portion was 1.74 μm².

This means that, the results of the simulations illustrated in FIG. 13 and FIG. 14 indicate that the simulation shown in FIG. 14 permits the coil interval H4 to be smaller, enabling the sectional area to be larger than that in the simulation shown in FIG. 13.

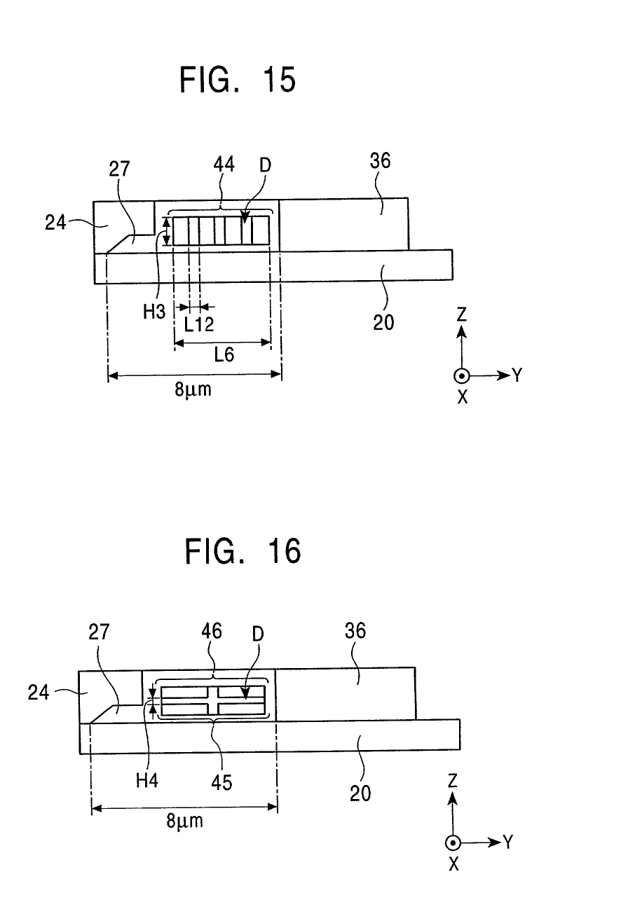

Referring now to FIG. 15, the single coil layer 44 is formed between the magnetic pole section 24 and the back gap layer 36 in the coil formation area D. The distance from the distal end of the Gd deciding layer 27, which distal end is adjacent to the surface opposing a recording medium, to the back gap layer 36 was set to 8 μm.

The length of the coil formation area D in the height direction was set to L6, and the height H3 thereof was set to 1.5 μm. A pitch interval L12 between conductive portions of the coil layer 44 was set to 0.6 μm.

The result of the simulation shown in FIG. 15 indicated that the length of each conductive portion in the height direction was 0.65 μm, the height was 1.5 μm, and therefore, the sectional area of the conductive portion was 0.975 μm².

Referring now to FIG. 16, the two coil layers 45 and 46 are formed between the magnetic pole section 24 and the back gap layer 36 in the coil formation area D. As in the case shown in FIG. 15, the distance from the distal end of the Gd deciding layer 27, which distal end is adjacent to the surface opposing a recording medium, to the back gap layer 36 was set to 8 μm.

The size of the coil formation area D and the pitch interval L12 between the conductive portions were set to the same values as those shown in FIG. 15. An interval H4 between the two coil layers 45 and 46 was set to 0.3 μm.

The result of the simulation shown in FIG. 16 indicated that the length of each conductive portion in the height direction was 1.9 μm, the height was 0.6 μm, and therefore, the sectional area of each conductive portion was 1.14 μm².

Thus, the results of the simulations have revealed that, when the distance from the distal end of the Gd deciding layer 27, which distal end is adjacent to the surface opposing a recording medium, to the back gap layer 36 is set to 8 μm, the sectional area of each conductive portion in the two-layer structure composed of the coil layers 45 and 46 shown in FIG. 16 can be made larger than that in the single-layer structure composed of the coil layer 44 shown in FIG. 15.

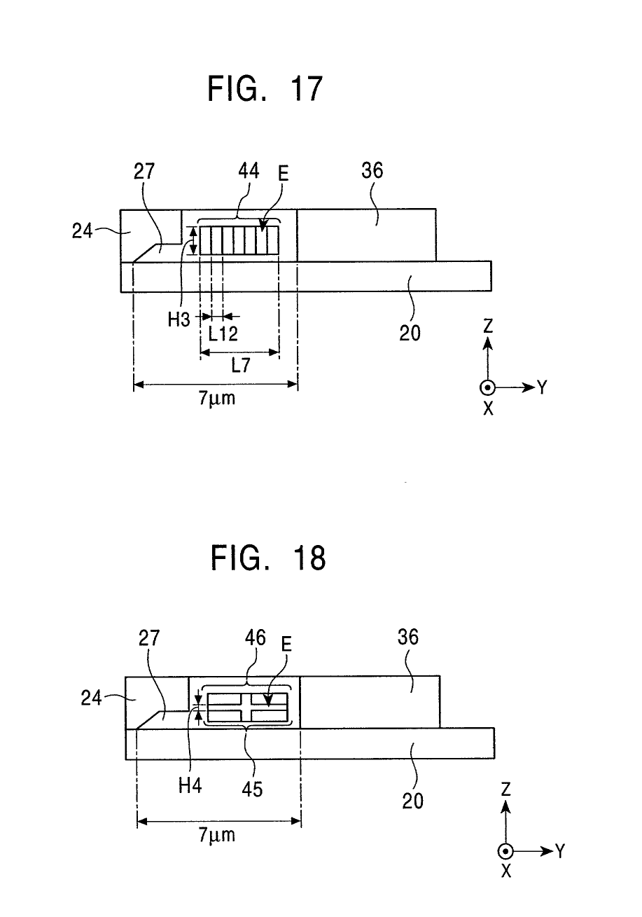

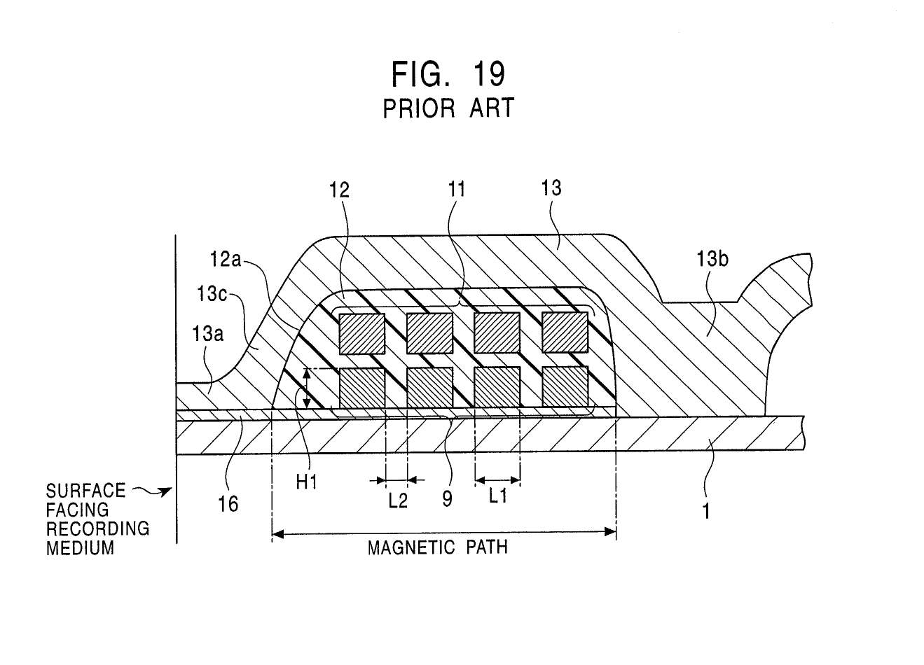

Referring to FIG. 17, the single coil layer 44 is formed between the magnetic pole section 24 and the back gap layer 36 in a coil formation area E. The distance from the distal end of the Gd deciding layer 27, which distal end is adjacent to the surface opposing a recording medium, to the back gap layer 36 was set to 7 μm.

The length of the coil formation area E in the height direction was set to L7, and a height H3 thereof was set to 1.5 μm. A pitch interval L12 between conductive portions of the coil layer 44 was set to 0.6 μm.

The result of the simulation shown in FIG. 17 indicated that the length of each conductive portion in the height direction was 0.4 μm, the height was 1.5 μm, and therefore, the sectional area of the conductive portion was 0.60 μm².

Referring now to FIG. 18, the two coil layers 45 and 46 are formed between the magnetic pole section 24 and the back gap layer 36 in the coil formation area E. As in the case shown in FIG. 17, the distance from the distal end of the Gd deciding layer 27, which distal end is adjacent to the surface opposing a recording medium, to the back gap layer 36 was set to 7 μm.

The size of the coil formation area E and the pitch interval L5 between the conductive portions were set to the same values as those shown in FIG. 17. The interval H4 between the two coil layers 45 and 46 was set to 0.3 μm.

The result of the simulation shown in FIG. 17 indicated that the length of each conductive portion in the height direction was 1.4 μm, the height was 0.6 μm, and therefore, the sectional area of each conductive portion was 0.84 μm².

Thus, the results of the simulations have revealed that, when the distance from the distal end of the Gd deciding layer 27, which distal end is adjacent to the surface opposing a recording medium, to the back gap layer 36 is set to 7 μm, the sectional area of each conductive portion in the two-layer structure composed of the coil layers 45 and 46 shown in FIG. 18 can be made larger than that in the single-layer structure composed of the coil layer 44 shown in FIG. 17.

As described above, in the same coil formation area wherein the single coil layer 44 having the vertically longer section is formed between the magnetic pole section 24 and the back gap layer 36, it is possible for the conductive portions of the coil layers 45 and 46 of the horizontally long sections to have larger sectional areas than that obtained when the single coil layer 44 of the vertically longer section is formed.

Especially when the distance from the distal end of the Gd deciding layer 27, which distal end is adjacent to the surface opposing a recording medium, to the back gap layer 36 is decreased, the sectional areas of the two horizontally long coil layers 45 and 46 can be increased in comparison with the sectional area of the single coil layer 44 having a vertically long section.

Furthermore, according to the present invention, providing the coil layers 29 and 37 with the horizontally long sectional shapes makes it possible to reduce the thickness of resist layers used for forming the coil layers, as shown in FIG. 3. Hence, the coil layers 29 and 37 can be formed with high pattern accuracy. In addition, decreasing the pitch L9 of the coil layers will not give rise to such a problem of short-circuiting between resist layer drawn patterns, thus permitting smaller pitches of coil layers to be achieved. Hence, magnetic paths can be further shortened by concentrating the coil layers in a limited coil formation area without the need for making sectional areas of the coil layers smaller.

Furthermore, according to the present invention, providing the coil layers 29 and 37 with the horizontally long sectional shapes also makes it possible to ensure adequate insulation even when the coil insulating layer 31 having a small film thickness H6 is formed between the coil layers 29 and 37. Hence, the coil insulating layer 31 can be formed more easily, and coil layers can be compactly formed in the limited coil formation area between the reference surface B and the lower core layer 20.

In the present invention, the coil insulating layers 31 and 30 are preferably formed of an inorganic insulating material. The coil insulating layers 31 and 30 are produced by sputtering. Using an inorganic insulating material for the coil insulating layers allows an interval H6 between the coil layers 29 and 37 to be made smaller.

As shown in FIG. 3, according to the present invention, the pitch interval L9 of the coil layers 29 and 37 is preferably set to be identical to the film thickness H5 of the coil layer or greater. This will allow the coil insulating layers 31 and 30 to easily enter the gaps between the coil layers, permitting secure insulation between coil layers.

Moreover, according to the present invention, a plurality of coil layers 29 and 37 can be compactly formed between the reference surface B and the lower core layer 20, so that the coil layers 39 and 41 formed between the reference surface B and the upper core layer 26 can be formed with a smaller number of turns as long as a predetermined number of turns is satisfied. Hence, the coil layers 39 and 41 can be easily formed to have square or horizontally long sections within a limited coil formation area between the reference surface B and the upper core layer 26. Accordingly, the bulging of the coil insulating layers 40 and 42 covering the coil layers 39 and 41 will be smaller, permitting the upper core layer 26 to be pattern-formed with an even film thickness.

Furthermore, in the present invention, the distance from the distal end of the Gd deciding layer 27, which distal end is adjacent to the surface opposing a recording medium, to the back gap layer 36 is set to L10, as shown in FIG. 3. To be more specific, the distance L10 preferably ranges from 5 μm to 10 μm. More preferably, in the present invention, the distance L10 ranges from 5 μm to 8 μm.

As the simulation results described above indicate, when the distance 10 is set to 10 μm or less, if the two coil layers 29 and 37 are formed according to the same design rule as that used for forming the single vertically long coil layer that extends from the magnetic pole section 24 to the back gap layer 36, then the sectional area of each conductive portion can be made larger than in the case where a single vertically long coil layer is formed. This means that, according to the present invention, even when the distance L10 is shortened, it is possible to properly control an increase in the coil resistance to control heat generated in the coils, thus permitting a magnetic path to be shortened further effectively.

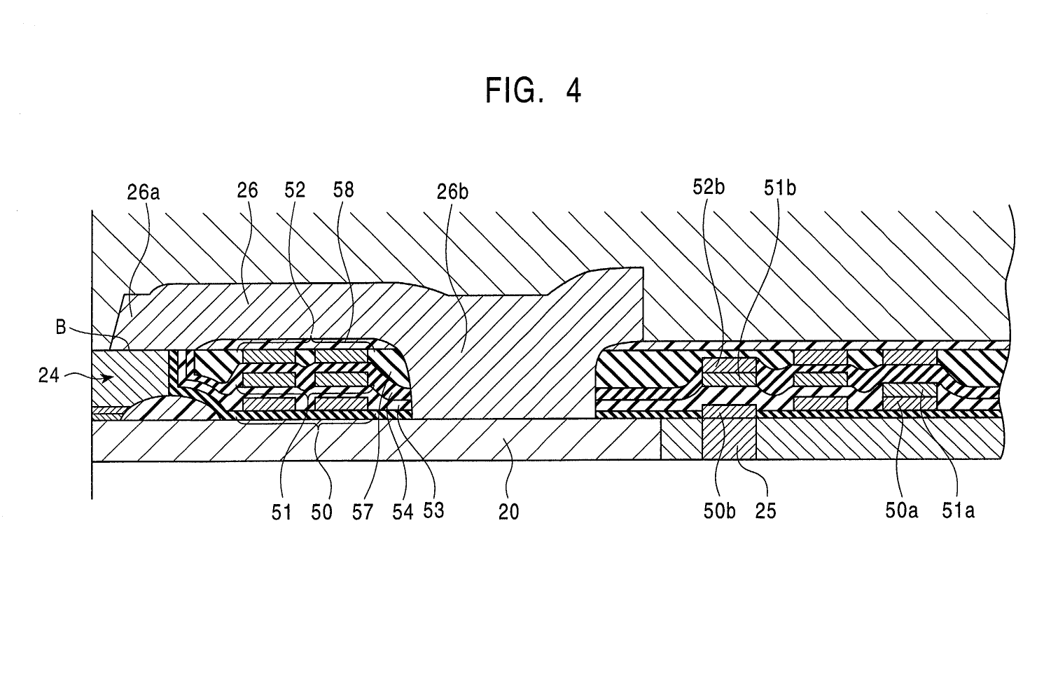

FIG. 4 is a longitudinal sectional view showing a thin film magnetic head according to a second embodiment of the present invention.

In this embodiment, three coil layers 50, 51, and 52 electrically connected in a step between the magnetic pole section 24 and the lower core layer 20 are tiered through the intermediary of coil insulating layers 53 and 54.

In this embodiment, the coil layer 52, which is the topmost layer of the above coil layers, is formed to be flush with a reference surface B and exposed at the reference surface B.

No coil layer is formed between the reference surface B and the upper core layer 26; instead, an insulating layer 58 composed of an organic insulating material, such as a resist or polyimide, for providing insulation is formed therebetween.

This embodiment allows tracks to be made narrower, and the three coil layers to be properly formed in a compact manner between the reference surface B and the lower core layer 20, so that the upper core layer 26 can be formed on a substantially flat surface. Hence, no large slope will be formed at the front of the upper core layer 26, and the upper core layer 26 can be easily formed with a uniform film thickness.

In order to properly form the three coil layers in a compact manner between the reference surface B and the lower core layer 20, it is preferable to provide the coil layers with square or horizontally long sections. This will allow the coil layers to have large sectional areas, and an increase in the DC resistance of the coil layers can be restrained.

In FIG. 4, the topmost layer, the coil layer 52, is exposedly formed on the same plane with the reference surface B, obviating the need for the contact 38 shown in FIG. 2.

Furthermore, the embodiment does not have the back gap layer 36 serving as the connection shown in FIG. 2. Instead, a proximal end (connection) 26b made integral with the upper core layer 26 is magnetically connected onto the lower core layer 20.

In addition, according to the embodiment, a winding center 50b of the coil layer 50 is conductively connected onto a lifting layer 25 formed in the lower core layer 20 at farther rear in the height direction. A winding end 50a of the coil layer 50 and a winding end 51a of the coil layer 51 formed thereon are conductively connected. Similarly, a winding center 51b of the coil layer 51 and a winding center 52b of the coil layer 52 formed thereon are also conductively connected.

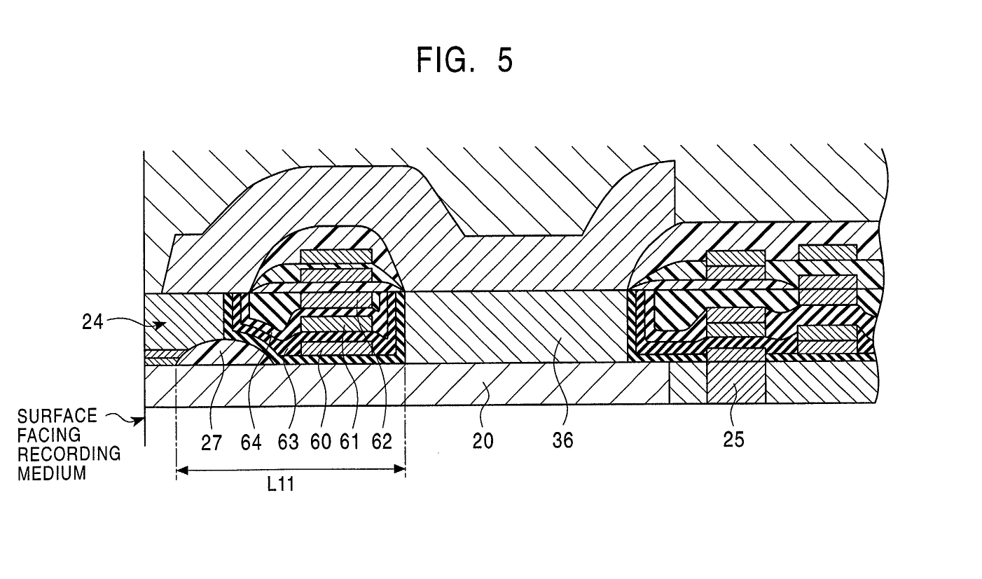

FIG. 5 is a longitudinal sectional view showing a thin film magnetic head according to another embodiment of the present invention.

In this embodiment also, three coil layers 60, 61, and 62 electrically connected in a step between a magnetic pole section 24 and a lower core layer 20 are tiered through the intermediary of coil insulating layers 63 and 64, as in the embodiment shown in FIG. 4.

In this embodiment, each of the coil layers 60, 61, and 62 wound between the magnetic pole section 24 and the back gap layer 36 has one turn.

This embodiment is effectively applied when a distance L11 from the distal end of the surface of the Gd deciding layer 27, which distal end is adjacent to the surface opposing a recording medium, to a back gap layer 36 is further shortened because of a shortened magnetic path.

Since each of the coil layers 60, 61, and 62 formed between the magnetic pole section 24 and the back gap layer 36 has one turn, there is no pitch interval between conductive portions. This means that the coil layers 60, 61, and 62 can be formed with even higher pattern accuracy. Moreover, the coil layers can be formed with sufficient lengths in the height direction between the magnetic pole section 24 and the back gap layer 36, so that the sectional areas of the coil layers can be effectively increased.

The descriptions have been given of the structures of the thin film magnetic heads in accordance with the present invention with reference to FIG. 1 through FIG. 5. The number of coil layers deposited between the reference surface B and the lower core layer 20 through the intermediary of the coil insulating layers may be any number as long as it is two or more.

The embodiment shown in FIG. 2 may alternatively be constructed so that the proximal end 26b of the upper core layer 26 may be directly formed on the lower core layer 20, omitting the back gap layer 36 as in the case of the embodiment shown in FIG. 4. Furthermore, the embodiment shown in FIG. 2 may alternatively be constructed so that the top surface of the second coil layer 37 is flush with the reference surface B as in the case of the embodiment shown in FIG. 4.

The embodiment shown in FIG. 2 has the third coil layer 39 and the fourth coil layer 41 between the reference surface B and the upper core layer 26; however, the number of the layers formed therebetween may be one or three or more. As another alternative, no coil layer may be formed between the reference surface B and the upper core layer 26.

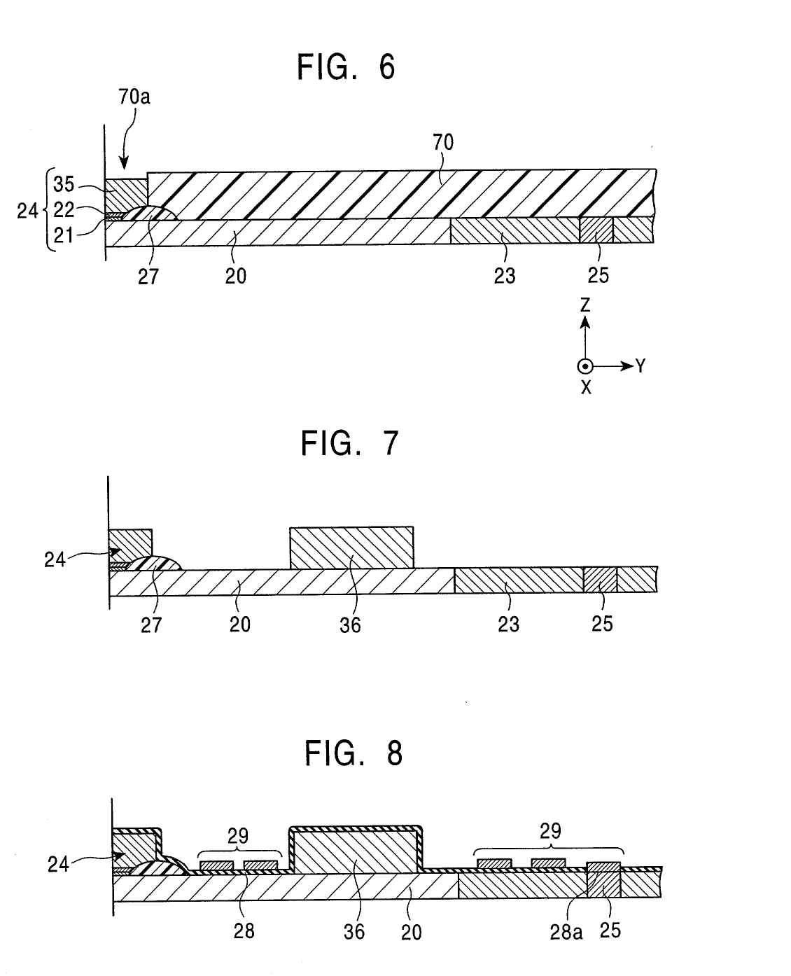

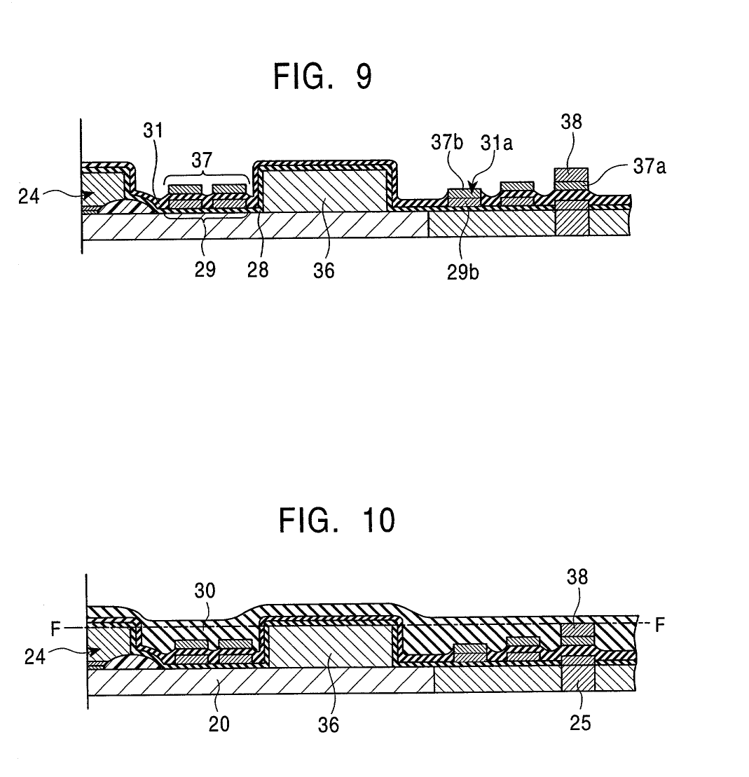

FIG. 6 through FIG. 12 illustrate process steps of the manufacturing method for the thin film magnetic head in accordance with the present invention shown in FIG. 2. All these diagrams are longitudinal sectional views.

In the step illustrated in FIG. 6, the lower core layer 20 is formed, and the lifting layer 25 is formed at the rear in the height direction (the direction Y in the drawing) of the lower core layer 20. Then, an insulating layer 23 made of an inorganic insulating material, such as Al₂O₃, is formed that extends from the top of the lower core layer 20, between the lower core layer 20 and the lifting layer 25, the top of the lifting layer 25, and to the rear in the height direction from the lifting layer 25. Then the CMP technique or the like is used to planarize the insulating layer 23 until the surface of the lower core layer 20 is exposed.

The Gd deciding layer 27 is formed on the lower core layer 20, then a resist layer 70 is formed on the lower core layer 20. A groove 70a for forming the magnetic pole section 24 at the end that faces a recording medium is formed by exposure.

In the subsequent step, the lower magnetic pole layer 21, the gap layer 22, and the upper magnetic pole layer 35 are continuously plated in the groove 70a to form the magnetic pole section 24. The magnetic pole section 24 may alternatively be constituted by two layers, namely, the gap layer 22 and the upper magnetic pole layer 35.

The resist layer 70 is removed, and another resist layer (not shown) for forming the back gap layer 36 is formed. Then, the groove that provides a drawing pattern of the back gap layer 36 is formed in the resist layer, and the back gap layer 36 is formed in the groove. FIG. 7 shows the configuration of the back gap layer 36 after the resist layer is removed.

In the step illustrated in FIG. 8, a coil insulating underlying layer 28 made of an inorganic insulating material, such as Al₂O₃, is formed that extends from the top of the magnetic pole section 24 to the lower core layer 20 and the back gap layer 36. At this time, a hole 28a is formed beforehand in the coil insulating underlying layer 28 formed on the lifting layer 25. Then, the first coil layer 29 is pattern-formed on the coil insulating underlying layer 28 by using a resist layer (not shown).

In the present invention, the coil layer 29 is preferably formed to have a square or horizontally long section, bottom side thereof parallel to the lower core layer 20 being larger than the film thickness of the coil layer 29. This arrangement makes it possible to secure a larger sectional area of the coil layer 29, form the coil layer 29 with high pattern accuracy by using a thinner resist layer, and reduce the pitch of the coil layer 29. Moreover, the coil insulating layer 31 covering the coil layer 29 can be formed in a reduced thickness, allowing the coil insulating layer 31 to be easily formed. The gaps of the coil layer 29 can be securely filled with the coil insulating layer 31 by setting the pitch of the coil layer 29 so that interval dimension in the direction parallel to the lower core layer 20 is not less than the film thickness of the coil layer 29.

Preferably, the coil insulating layer 31 is formed by an inorganic insulating material, and the coil insulating layer 31 is produced by sputtering. The inorganic insulating material is preferably at least one of AlO, Al₂O₃, SiO₂, Ta₂O₅, TiO, AlN, AlSiN, TiN, SiN, Si₃N₄, NiO, WO, WO₃, BN, CrN, and SiON.

According to the present invention, the surface of the coil insulating layer 31 formed on the first coil layer 29 can be substantially planarized. Hence, in the subsequent step, the second coil layer 37 is formed on the coil insulating layer 31 with high pattern accuracy by using a resist layer (not shown).

When forming the second coil layer 37, the hole 31a is formed beforehand in a portion of the coil insulating layer 31 where the winding center 37b of the second coil layer 37 is to be formed. When the second coil layer 37 has been formed, the winding center 37b and the winding center 29b of the first coil layer 29 are conductively connected.

According to the present invention, as in the case of the first coil layer 29, a thinner resist layer can be used for forming the second coil layer 37, so that high pattern accuracy can be ensured even when the pitch of the second coil layer 37 is made narrower.

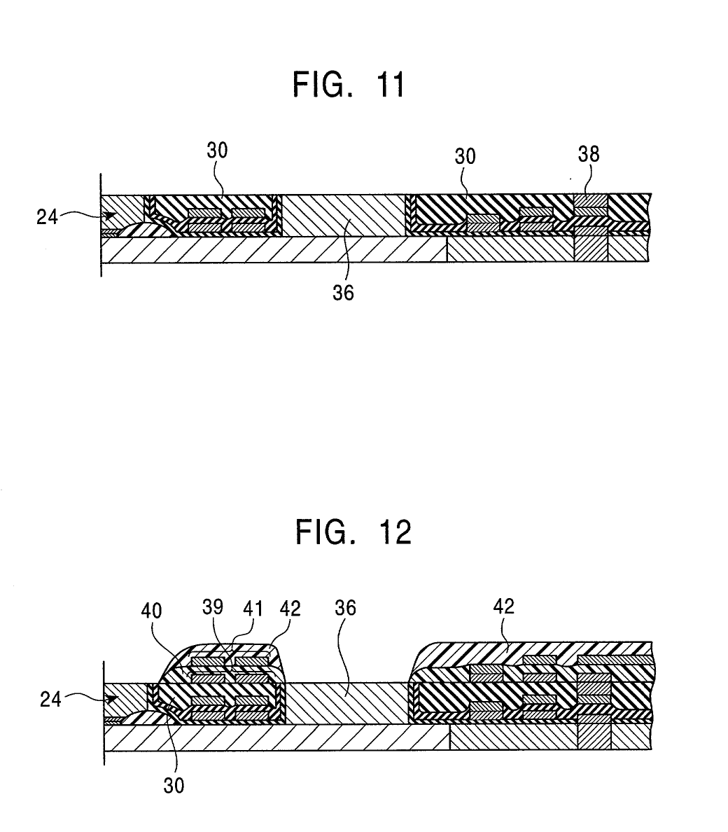

In the step shown in FIG. 11, the coil insulating layer 30 is formed by sputtering on the second coil layer 37, the magnetic pole section 24, and the back gap layer 36. Preferably, the coil insulating layer 30 is formed by an inorganic insulating material. The inorganic insulating material is preferably at least one of AlO, Al₂O₃, SiO₂, Ta₂O₅, TiO, AlN, AlSiN, TiN, SiN, Si₃N₄, NiO, WO, WO₃, BN, CrN, and SiON.

In the next step according to the present invention, as shown in FIG. 10, the coil insulating layer 30 is polished to the line F-F. After the polishing step, the top surface of the magnetic pole section 24, the top surface of the back gap layer 36, and the top surface of the contact 38 are exposed at the surface of the coil insulating layer 30, as shown in FIG. 11.

Subsequently, in the step illustrated in FIG. 12, the third coil layer 39 is pattern-formed on the coil insulating layer 30 by using a resist layer (not shown), then the coil insulating layer 40 made of an organic insulating material, such as a resist or polyimide, is formed on the third coil layer 39. Next, the four coil layer 41 is pattern-formed on the coil insulating layer 40 by using a resist layer (not shown). Then, the coil insulating layer 42 made of an organic insulating material, such as a resist or polyimide, is formed on the fourth coil layer 41.

Then, the upper core layer 26 is formed by, for example, the frame plating process or the like, to cover the magnetic pole section 24, the coil insulating layer 42, and the back gap layer 36, which are shown in FIG. 12, and the protective layer 43 is formed on the upper core layer 26 to complete the thin film magnetic head shown in FIG. 2.

To directly connect the proximal end 26b of the upper core layer 26 onto the lower core layer 20 without forming the back gap layer 36 on the lower core layer 20, as shown in FIG. 4, the layers up to the insulating layer 42 covering the fourth coil layer 41 are deposited, then the portion of the coil insulating layer 30 in which the proximal end 26b of the upper core layer 26 is to be formed is removed by etching to expose the lower core layer 20. Thereafter, the proximal end 26b of the upper core layer 26 is formed on the exposed lower core layer 20 to complete the thin film magnetic head shown in FIG. 4.

According to the present invention, it is also possible to form, in the step shown in FIG. 12, the upper core layer 26 from the magnetic pole section 24 to the back gap layer 36 without forming the third coil layer 39 and the fourth coil layer 41.

As described in detail above, the magnetic pole section for restricting track width is formed between the lower core layer and the upper core layer, and two or more coil layers are disposed in an area at the rear side of the magnetic pole thereby achieving a shorter magnetic path. As a result, a narrower track and lower inductance can be both realized, and the narrower track combined with faster data transfer enables higher-density recording to be accomplished.

To form efficiently form the coil layers in the limited coil formation area between the reference surface, which is the joining surface of the magnetic pole section and the upper core layer, and the lower core layer, the coil layers are preferably formed to have square or horizontally long sections. More specifically, as compared with a case where coil layers having vertically long sections are densely formed in the height direction, the sections of the coil layers having the same number of turns as that of the above coil layers can be made larger, and an increase in the DC resistance of the coil layers can be restrained by vertically laminating the coil layers that have square or horizontally long sections.

Furthermore, the coil layers can be formed by using thinner resist layers, so that the coil layers can be formed with high pattern accuracy, and the coil layers permit narrower pitches to be achieved. This allows magnetic paths to be made even shorter.

Moreover, insulation can be accomplished by forming a thin coil insulating layer on the coil layer, the coil insulating layer can be easily formed, and coil layers with larger sectional areas can be efficiently formed in a small coil formation area.

In addition, by forming the gaps in each coil layer in a spiral pattern and between coil layers to have square or horizontally long shapes, the coil insulating layer can be securely filled in the gaps. Preferably, the coil insulating layers are formed of an inorganic insulating material.

What is claimed is:

1. A thin film magnetic head wherein:
at a surface side opposing a recording medium, a lower core layer and an upper core layer are positioned with a gap provided therebetween in a direction of sliding against a recording medium, and a magnetic pole section constituted by a lower magnetic pole layer having a predetermined width in a track width direction, a gap layer, and an upper magnetic pole layer, or by the gap layer and the upper magnetic pole layer is provided between the lower core layer and the upper core layer;
a connecting portion for magnetically connecting the lower core layer and the upper core layer is provided at the rear in a height direction away from the opposing surface;
coil layers in spiral patterns are formed around the connecting portion; and
the spiral patterns of the coil layers are disposed such that they are overlapped in a plurality of layers in the above sliding direction in an area sandwiched between a reference surface, which is obtained by extending the connecting surface of the lower core layer and the magnetic pole section in the height direction, and the lower core layer.

2. The thin film magnetic head according to claim 1, wherein the sectional shape of the coil layer positioned in the area sandwiched between the reference surface and the lower core layer is such that the length of the bottom side thereof that is parallel to the lower core layer is not less than the film thickness of the coil layer.

3. The thin film magnetic head according to claim 1, wherein the pitch of each of the coil layers is formed such that the interval dimension in the direction parallel to the lower core layer is not less than the film thickness of the coil layer.

4. The thin film magnetic head according to claim 1, wherein a back gap layer made of a magnetic material is formed on the lower core layer in the connecting portion, the back gap layer and the upper core layer are magnetically connected, and the coil layer is positioned in the area sandwiched between a reference surface, which connects the top surface of the magnetic pole section and the top surface of the back gap layer, and the lower core layer.

5. The thin film magnetic head according to claim 1, wherein a Gd deciding layer for deciding the depth of the gap layer in the height direction is provided on the lower core layer, and at least the coil layer, which is a bottommost layer adjacent to the lower core layer, is positioned at the rear of the Gd deciding layer in the height direction.

6. The thin film magnetic head according to claim 1, wherein the depth from the distal end of the Gd deciding layer, which distal end is adjacent to the surface opposing a recording medium, to the connecting portion for magnetically connecting the lower core layer and the upper core layer ranges from 2 μm to 6 μm.

7. The thin film magnetic head according to claim 1, wherein the insulating layer covering a lower coil layer and the insulating layer covering an upper coil layer are both formed of an inorganic insulating material.

8. The thin film magnetic head according to claim 1, wherein still another coil layer is disposed between the reference surface and the upper core layer.
